(19) United States
(12) Patent Application Publication
(10) Pub. No.: US 2006/0235160 A1
(43) Pub. Date: Oct. 19, 2006

(54) Water-borne resin composition for polyolefin and method of preparing the same

(75) Inventors: Jong-Sook Park, Anyang-si (KR); Seung-Young Choi, Seoul (KR); Chul-Yong Kim, Daegu (KR)

Correspondence Address: MAYER, BROWN, ROWE & MAW LLP, 1909 K STREET, N.W., WASHINGTON, DC, 20006, US

(73) Assignee: DPI CO., LTD.

(21) Appl. No.: 11/222,839

(22) Filed: Sep. 12, 2005

(30) Foreign Application Priority Data
Apr. 19, 2005 (KR) 10-2005-0032485

(51) Int. Cl. C08F 297/02

(52) U.S. Cl. 525/242

(57) ABSTRACT

A water-borne resin composition for polyolefin is obtained by graft polymerizing polypropylene chloride resin having a chlorine degree of about 10-40% and an acryl monomer. First, polypropylene chloride resin solution is prepared by mixing about 5-30 parts by weight of polypropylene chloride resin having a chlorine degree of about 10-40 and about 5-30 parts by weight of a hydrophilic solvent. Then, an acryl monomer solution is prepared by mixing about 70-95 parts by weight of an acryl monomer, a solvent and an initiator. The acryl monomer solution is dropped into the polypropylene resin solution at a temperature of about 80-130° C. and thus obtained product is neutralized and diluted. The composition has a good adhesiveness onto polyolefin, so that the composition may be applied as a water-borne paint composition for polyolefin-based substrate.

### CROSS REFERENCE TO RELATED APPLICATION

This application relies for priority upon Korean Patent Application No. 2005-32485 filed on Apr. 19, 2005, the contents of which are herein incorporated by reference in its entirety.

### BACKGROUND OF THE INVENTION

1. Field of the Invention

The present invention relates to a water-borne resin composition for polyolefin and a method of preparing the water-borne resin composition for polyolefin. More particularly, the present invention relates to a water-borne resin composition for polyolefin, having a good adhesiveness and a method of preparing the water-borne resin composition for polyolefin.

2. Description of the Related Arts

Plastic material is widely used in manufacturing a bumper of an automobile, preparing materials of an interior decoration, and the like. The use of the plastic material is gradually increased nowadays. In particular, as products become lightweight, consumption of polyolefin material is gradually increased and the usage of polyolefin is more expended.

Polyolefin is prepared by polymerizing olefin having a double bond at the terminal portion of polyolefin and includes polyethylene, polypropylene and polyisobutylene. Examples of polymer of 4-methyl pentene synthesized from propylene include polymethyl pentene resin, methyl pentene resin, etc. A density of polyolefin is about 0.83 g/cm³ and is known as one of the most lightweight plastics. A melting point of polyolefin is about 350° C. and a thermal deforming temperature of electric charge is about 200° C. Generally, polyolefin is more transparent than glass.

Polypropylene is a polymer of propylene. Propylene is prepared with ethylene during decomposing naphtha in a petrochemical plant. Polypropylene is advantageously prepared through obtaining Ziegler-Natta catalyst in hexane and then passing propylene at a temperature of about 75° C. and a pressure of 5 atm through the hexane solution. Polypropylene has an isotactic structure and methyl groups in polypropylene are arranged in one direction in a regular manner. A melting point of polypropylene is about 165° C. and a density is about 0.9-0.91 g/cm³. An injection molding body is generally applied for manufacturing articles for daily usage, and a synthesized fiber is mostly applied for manufacturing strong industrial supplies, carpet and cotton for bedclothes. An extrude body is applied for manufacturing paper, steel bands and matting. A hollow body is safe with respect to flowing liquid having a high temperature and so is applied for manufacturing a thermos bottle, medical instruments for thermal sterilization, medicinal vessels, etc.

In order to apply components prepared from polypropylene for manufacturing an automobile, a painting process is essential to harmonize the color of the automobile. However, polypropylene has a non-polar molecular structure and a high inner crystalline property, as a result, the polypropylene has an inferior adhesiveness in the paint composition. Therefore, chemical or physical treatment is required to adhere a desired paint composition onto a target material prepared from polypropylene.

Conventionally, a chemical treatment was implemented using fluoric acid and ozone and a physical treatment was implemented using plasma and corona discharge. However, these methods cost a great deal and induce environmental problems. Accordingly, a primer method using polypropylene resin, polypropylene chloride resin, acryl resin, etc. is widely used. However, compatibility between applied resins is not sufficient and external appearance of a product on which a coating layer is formed, is deteriorated due to an orange peel or a color separation because of a pigment dispersing property and specific gravity difference between the resins.

Polypropylene chloride resin can be used to implement an acryl graft polymerization to obtain an oily resin having a good external appearance and compatibility. However, when a paint composition is prepared using the oily resin, toxic solvents included in the composition injure the workers and induce displeasure during working. In addition, in view of an environmental protection, a harmful influence is exerted. Accordingly, a water-borne product having similar quality with the conventional product is required to replace the conventional oily product to restrain the use of the oily solvent.

### SUMMARY OF THE INVENTION

The present invention provides a water-borne resin composition obtained through a graft polymerization of polypropylene chloride resin and acryl monomer, and having a good adhesiveness to a polyolefin substrate and a good storing stability.

The present invention also provides a method of preparing a water-borne resin composition for polyolefin including dropping a mixture of an acryl monomer, a hydrophilic solvent and an initiator into a polypropylene chloride resin solution of which temperature is about 80-130° C., neutralizing using an amine and diluting using water.

In one aspect of the present invention, there is provided a water-borne resin composition for polyolefin obtained by graft polymerizing about 5-30 parts by weight of polypropylene chloride resin having a chlorine degree of about 10-40% and about 70-95 parts by weight of an acryl monomer.

In another aspect of the present invention, there is provided a method of preparing a water-borne resin composition for polyolefin. First, polypropylene chloride resin solution is prepared by mixing about 5-30 parts by weight of polypropylene chloride resin having a chlorine degree of about 10-40% and about 5-30 parts by weight of a hydrophilic solvent. Then, an acryl monomer solution is prepared by mixing about 70-95 parts by weight of an acryl monomer, a solvent and an initiator. Third, the acryl monomer solution is dropped into the polypropylene resin solution at a temperature of about 80-130° C. and thus obtained product is neutralized and diluted.

According to the present invention, the water-borne resin composition for polyolefin obtained by graft polymerizing commercially available polypropylene chloride resin and a monomer having a carboxyl functional group in a predetermined ratio, is provided. A water-borne paint composition having a good adhesiveness and an improved storing stability may be prepared without implementing an additional treatment.

In addition, the water-borne resin composition for polyolefin is a thermoplastic resin and can be used alone or after mixing with a cross-linking agent such as an amino resin or a reactive urethane resin, to form a coating layer through a curing reaction by applying heat. Through improving the mechanical properties including hardness and scratch-resistance, and chemical properties including gasoline-resistance, acid-resistance and water-resistance, the water-borne resin composition of the present invention may be advantageously applied for manufacturing the components for an automobile.

### DESCRIPTION OF THE INVENTION

Hereinafter, the present invention will be described in detail.

The water-borne resin composition for polyolefin of the present invention includes polypropylene chloride resin having a good adhesiveness onto a polyolefin-based substrate. A portion of hydrogen is replaced with chlorine in the polypropylene chloride resin. The preferred polypropylene chloride has chlorine degree of about 10-40% by weight. The chlorine degree represents the weight of chlorine based on the total amount of the polypropylene chloride resin. A molecular weight of polypropylene chloride is about 20,000-100,000 g/mol.

For example, a liquid-type resin such as HAEDLEN 14-LLB, 14ML, CY9122, B-13-MLJ and B-4000 purchased from Toyo Kagaku Co., Ltd. in Japan and a solid-type resin such as HARDLEN 14-LWP and CY-9122P purchased from the same company, may be used. In addition, commercially available products having similar properties with the chloride resin such as SUPERCHLON purchased from Japanese Paper Co., Ltd. in Japan and Chloride resin purchased from EASTMAN Co., Ltd. in U.S.A., also may be advantageously used. In the examples of the present invention, the products purchased from Toyo Kagaku Co., Ltd. in Japan are used. However, any products satisfying the above-defined chloride degree can be used.

When the amount of the polypropylene chloride resin is less than about 5 parts by weight based on 100 parts by weight of the solid content of reacting resin (or referred to as resinous reactant), adhesiveness to a substrate and chemical properties including gasoline-resistance and alkaline-resistance are deteriorated. When the amount of the polypropylene chloride resin exceeds about 30 parts by weight, the required amount of expensive polypropylene chloride resin increases the preparing cost. When considering the increase of the effect according to the increase of the amount of the propylene chloride resin, it is not preferable in economical view point. In addition, viscosity of the resin solution increases to deteriorate working efficiency. Further, dispersing property of pigments in a dried coating layer is not sufficient, thereby easily generating color separation. Therefore, the preferred amount of the polypropylene resin is about 5-30 parts by weight based on 100 parts by weight of the solid content of a reacting resin, and more preferably, about 10-20 parts by weight.

The water-borne resin composition for polyolefin includes an acryl monomer. When the amount of the acryl monomer by the solid content, is less than about 70 parts by weight, an affinity with an organic pigment or inorganic pigment is lowered to generate a color separation phenomenon. In addition, the increase of the amount of the polypropylene chloride resin increases the cost of the preparation of the resin composition. On the contrary, when the amount of the acryl monomer exceeds about 95 parts by weight, adhesiveness onto a substrate that is polyolefin plastic is lowered. Accordingly, the preferred amount of the acryl monomer is about 70-95 parts by weight based on 100 parts by weight of the solid content of the reacting resin.

Examples of the acryl monomer may include a non-functional acryl monomer, an acryl monomer having a hydroxyl functional group, an acryl monomer having a carboxyl functional group, etc. The non-functional acryl monomer may include an aliphatic acryl monomer, an acryl monomer containing an alkyl group, etc.

When the amount of the aliphatic acryl monomer is less than about 15% by weight based on the total amount of the acryl monomer, the preparation of a resin having a good flexibility and rapid drying property is difficult. When the amount exceeds about 35% by weight, the cost of the resin increases and compatibility with the pigment is deteriorated to induce the color separation. Accordingly, the preferred amount of the aliphatic acryl monomer is about 15-35% by weight based on the amount of the acryl monomer.

When the acryl monomer having the alkyl group is less than 50% by weight based on the total amount of the acryl monomer, an increase of the aliphatic acryl monomer among the total acryl monomer increases the cost of the resin. When the amount exceeds about 70% by weight, both high flexibility and rapid drying property are difficult to accomplish. Accordingly, the preferred amount of the acryl monomer having the alkyl group is about 50-70% by weight based on the amount of the acryl monomer.

When the amount of the acryl monomer having the carboxyl functional group is less than about 1% by weight based on the total acryl monomer, diluting property in water after neutralizing is deteriorated to lower the stability of a paint composition. When the amount exceeds about 10% by weight, water-resistance after the neutralization is lowered and a curing reaction of urethane used as a cross-linking agent is inhibited. Accordingly, the preferred amount of the acryl monomer having the carboxyl group is about 1-10% by weight based on the acryl monomer, and more preferably, the amount is in the range of about 3-6% by weight.

When the amount of the acryl monomer having the hydroxyl functional group is less than about 5% by weight based on the total acryl monomer, the amount of the functional group possibly making a bridge bond is insufficient, and the stability with respect to a metal pigment liable to ionize, is deteriorated. When the amount exceeds about 15% by weight, water-resistance is lowered and the resin becomes opaque. Accordingly, the preferred amount of the acryl monomer having the hydroxyl functional group is about 5-15% by weight based on the amount of the acryl monomer.

Examples of the aliphatic acryl monomer may include isobornyl acrylate, cyclohexyl acrylate, isobornyl methacrylate, cyclohexyl methacrylate, etc. These can be used alone or in a mixture thereof. Examples of the acryl monomer having an alkyl group may include methyl methacrylate, ethyl acrylate, n-butyl acrylate, methyl methacrylate, n-butyl methacrylate, isobutyl methacrylate, acrylonitrile, etc. These can be used alone or in a mixture thereof.

Examples of the acryl monomer including the hydroxyl functional group may include 2-hydroxyethyl methacrylate, 2-hydroxyethyl acrylate, hydroxypropyl acrylate, hydroxypropyl methacrylate, hydroxybutyl acrylate, etc. These can be used alone or in a mixture thereof. Examples of the acryl monomer having the hydroxyl group may include acrylic acid, methacrylic acid, etc. These can be used alone or in a mixture thereof.

The water-borne resin composition of the present invention may further include an initiator. The initiator may include a peroxide-based initiator including benzoyl peroxide, tert-butyloxy peroxy benzoate and tert-butyl peroxy 2-ethyl hexanate, an azo-based compound including azobis iso-butylonitrile, etc.

Generally, when the peroxide-based initiator such as benzoyl peroxide is used as the initiator, desired graft copolymer is advantageously obtained. On the contrary, when azobis iso-butylonitrile is used as the initiator, 2-cyano-2-propyl radical produced from azobis iso-butylonitrile restrains the graft reaction of the radical due to resonance stabilization. That is, the grafting efficiency of the acryl monomer is lowered to produce only a mixture of acryl homo-polymer. In addition, the compatibility of the polypropylene chloride resin and the acryl homo-polymer is poor to produce an opaque resin.

Accordingly, benzoyl peroxide is recommended as the graft reaction initiator of the acryl monomer. The usage of benzoyl peroxide gives graft copolymer in a high yield. Preferably, the peroxide initiator including benzoyl peroxide is preferred for the graft polymerization of the polypropylene chloride resin with the acryl monomer.

Here, when the amount of the initiator is about 0.1% by weight based on about 100% by weight of the acryl monomer, the amount of the initiator is too small with respect to the amount of the acryl monomer, thereby lowering the grafting efficiency. When the amount exceeds about 5% by weight, the initiator is present in the prepared resin solution to exert a bad influence onto a cured coating layer. Accordingly, the preferred amount of the initiator is about 0.1-5% by weight based on about 100% by weight of the acryl monomer.

When the glass transition temperature of acryl among the components is less than about 20° C., physical properties including the hardness and scratch-resistance of a harden coating layer are lowered, and when the glass transition temperature exceeds about 80° C., minute cracks of the harden coating layer are generated to lower adhesiveness and chemical properties including water-resistance and acid-resistance. Therefore, the preferred glass transition temperature is in the range of about 20-80° C.

When the hydroxide value of thus obtained resin composition is less than about 5 mg KOH/g, the amount of the functional group for bridge bond is not sufficient and bridging density is not heightened. Therefore, physical properties including hardness and scratch-resistance are lowered and chemical properties including gasoline-resistance are also deteriorated. When the hydroxide value of the resin composition exceeds about 50 mg KOH/g, water-resistance is deteriorated and an excessive amount of a cross-linking agent resin is required to lower acid-resistance. Accordingly, the preferred hydroxide value of the resin composition is about 5-50 mg KOH/g and more preferred value is about 10-40 mg KOH/g.

When the acid value of the resin composition is less than 6.5 mg KOH/g, the viscosity after neutralizing and diluting is high or a phase separating phenomenon is generated. When the acid value exceeds about 65 mg KOH/g, an excessive amount of carboxyl functional group is present in the cured coating layer to deteriorate chemical properties including water-resistance and alkaline-resistance. Accordingly, the preferred acid value of the resin composition according to the present invention is in a range of about 18-38 mg KOH/g.

When a number average molecular weight of the resin composition is less than about 60,000, the chemical properties including acid-resistance, alkaline-resistance and gasoline-resistance of the cured coating layer are deteriorated. When the number average molecular weight exceeds about 150,000, the viscosity of the resin composition is excessively increased to lower working efficiency and increase the amount of a solvent to deteriorate adhesiveness of the coating layer. Accordingly, the preferred number average molecular weight of the resin composition is of about 60,000-150,000.

Hereinafter, the method of preparing the water-borne resin composition for polyolefin according to the present invention will be described in detail.

About 5-30% by weight of polypropylene chloride resin having chlorine degree of 10-40% by weight is prepared based on the amount of an initially added solute, and about 70-95% by weight of acryl monomer is prepared based on the amount of the initially added solute.

A polypropylene chloride resin solution is prepared by mixing the polypropylene chloride resin and a hydrophilic solvent. The polypropylene chloride resin solution is prepared by completely dissolving the polypropylene chloride resin into the solvent at a temperature of about 80-130° C. within a flask provided with a thermometer, condenser and a stirrer.

An acryl monomer solution is prepared by mixing the acryl monomer, a hydrophilic solvent and an initiator. The acryl monomer is prepared by mixing various kinds of monomers in a predetermined mixing ratio.

Thereafter, the acryl monomer solution is added into the polypropylene chloride resin composition drop by drop at a temperature of about 80-130° C. The acryl monomer mixture is added drop by drop by a constant amount for about 3 hours. After completing the reaction, the product is neutralized using an amine compound by the equivalent corresponding to the equivalent of the monomer having the carboxyl functional group among the monomers added as a reactant. Then, the product is diluted using de-ionized water.

The method of forming a coating layer using the water-borne resin composition for polyolefin having the above-described properties will be described in detail below.

The water-borne resin composition prepared by the present invention is diluted using de-ionized water to prepare a paint composition having a resin solid content of about 30% by weight excluding a cross-linking agent. A paste, an additional agent and an adhesiveness increasing agent are added into the paint composition. Here, the paste is obtained by dispersing an inorganic pigment that is titanium dioxide into an aqueous acrylic resin purchased from DPI Co., Ltd. in Korea. The additional agent is a leveling agent. The viscosity of the paint composition is adjusted using additional de-ionized water.

The paint composition is coated by means of an air spraying method on a substrate formed by using polypropylene resin that is polyolefin-based material. After completing the coating, the coated layer is cured by drying at a temperature of about 85° C. for about 30 minutes.

Hereinafter, the present invention is described in detail with reference to the following examples. The examples are given solely for the purpose of illustration and are not to be construed as limitations of the present invention, as many variations thereof are possible without departing from the spirit and scope of the invention.

### EXAMPLE 1

Into about 1000 g of butyl cellosolve as a solvent, about 430 g of HARDLEN 14-LLB (trade name manufactured by Toyo Kagaku Co., Ltd. in Japan) was added as a polypropylene chloride resin. The reactant was heated to a temperature of about 100° C. to homogeneously mix polypropylene chloride resin solution. Then, the acryl resin solution obtained by mixing the components below was added into the polypropylene chloride solution drop by drop.

| | |
|---|---|
| n-butyl acrylate | 400 g |
| n-butyl methacrylate | 320 g |
| methyl methacrylate | 500 g |
| 2-hydroxyethyl methacrylate | 200 g |
| isobornyl methacrylate | 500 g |
| methacrylic acid | 80 g |
| benzoyl peroxide | 4 g |
| butyl cellosolve | 220 g |
| total | 2224 g |

After completing the dropping, about 2 g of benzoyl peroxide was added and the reaction was kept for about 2 hours. Then, about 94 g of tri-ethyl amine was added to neutralize and about 756 g of de-ionized water was slowly added to dilute the product. Thus prepared water-borne resin composition for polypropylene had a hydroxide value of about 15 mg KOH/g and an acid value of about 21.5 mg KOH/g with respect to the solid content of the resin. The Gardner viscosity at a temperature of about 25° C. of the resin solution was Z and the number average molecular weight was about 65,000 and the solid content of the resin was about 45%.

### EXAMPLE 2

Into about 28809 of butyl cellosolve as a solvent, about 420 g of HARDLEN 14-LWP (trade name manufactured by Toyo Kagaku Co., Ltd. in Japan) was added as a polypropylene chloride resin. The reactant was heated to a temperature of about 90° C. to dissolve the polypropylene chloride resin. Thereafter, the acryl resin solution obtained by mixing the components below was added into the polypropylene chloride solution drop by drop.

| | |
|---|---|
| n-butyl acrylate | 330 g |
| iso-butyl methacrylate | 240 g |
| methyl methacrylate | 960 g |
| 2-hydroxyethyl methacrylate | 210 g |
| isobornyl methacrylate | 540 g |
| methacrylic acid | 200 g |
| benzoyl peroxide | 18 g |
| butyl cellosolve | 72 g |
| total | 2570 g |

After completing the dropping, about 4 g of benzoyl peroxide was added and the reaction was kept for about 2 hours. Then, about 235 g of tri-ethyl amine was added to neutralize and about 1025 g of de-ionized water was slowly added to dilute the product. Thus prepared water-borne resin composition for primer had a hydroxide value of about 12 mg KOH/g and an acid value of about 45 mg KOH/g with respect to the solid content. The Gardner viscosity at a temperature of about 25° C. of the resin solution was Z2 and the number average molecular weight was about 80,000 and the solid content of the resin was about 40%.

### EXAMPLE 3

Into about 2000 g of butyl cellosolve as a solvent, about 200 g of HARDLEN CY-9122P (trade name manufactured by Toyo Kagaku Co., Ltd. in Japan) was added as a polypropylene chloride resin. The reactant was heated to a temperature of about 90° C. to completely dissolve the polypropylene chloride resin. Then, the acryl resin solution obtained by mixing the components below was added into the polypropylene chloride solution drop by drop.

| | |
|---|---|
| n-butyl acrylate | 200 g |
| iso-butyl methacrylate | 150 g |
| methyl methacrylate | 440 g |
| 2-hydroxyethyl methacrylate | 160 g |
| cyclohexyl methacrylate | 620 g |
| acrylonitrile | 90 g |
| methacrylic acid | 200 g |
| benzoyl peroxide | 5 g |
| butyl cellosolve | 200 g |
| total | 2065 g |

After completing the dropping, about 5 g of benzoyl peroxide was added and the reaction was kept for about 2 hours. Then, about 235.3 g of tri-ethyl amine was added to neutralize and about 1130 g of de-ionized water was slowly added to dilute the product. Thus prepared water-borne resin composition for polypropylene had a hydroxide value of about 9 mg KOH/g and an acid value of about 63 mg KOH/g with respect to the solid content. The Gardner viscosity at a temperature of about 25° C. of the resin solution was Z and the number average molecular weight was about 110,000 and the solid content of the resin was about 30%.

### COMPARATIVE EXAMPLE 1

About 500 g of butyl cellosolve was heated to a temperature of about 110° C. Then, the mixture of the following components was added drop by drop.

| | |
|---|---|
| Styrene | 165 g |
| Methyl methacrylate | 25 g |
| n-butyl acrylate | 150 g |
| cyclohexyl methacrylate | 155 g |
| acrylic acid | 20 g |
| benzoyl peroxide | 2 g |
| total | 504 g |

After completing the dropping, about 1 g of benzoyl peroxide was added twice in an hour, while keeping the reaction going. An acryl resin having an acid value of about 30 mg KOH/g, Gardner viscosity at a temperature of about 25° C. of X, the number average molecular weight of 25,000 and the solid content of about 50%, was obtained. Into the acryl resin, about 10% by weight of polypropylene chloride resin solution, into which about 20% by weight of HARDLEN CPO EW-5303 (trade name manufactured by Toyo Kagaku Co., Ltd. in Japan) was dissolved as a water-borne polypropylene chloride resin, was slowly added to prepare a blended water-borne resin for polypropylene.

Then, coating layers were formed using the resin compositions prepared from Examples 1-3 and Comparative Example 1.

Experiment 1

Into a paint composition including about 25% by weight of the resin composition prepared by Example 1, about 55% by weight of an aqueous pigment paste, about 2% by weight of an additional agent and about 0.5% by weight of adhesiveness increasing agent were added, and de-ionized water was added to adjust the viscosity at a temperature of about 25° C. of the composition to 35″ by Ford cup No. 4. Polypropylene substrate of which grease was removed using isopropyl alcohol was coated using the paint composition to a thickness of the coating layer of about 10-30 μm. Then, the substrate was coated with R-266 clear product and dried in a drier at a temperature of 85° C. for 30 minutes to cure the coated paint composition.

Experiment 2

Into a paint composition including about 25% by weight of the resin composition prepared by Example 2, about 55% by weight of an aqueous pigment paste, about 2% by weight of an additional agent and about 0.5% by weight of an adhesiveness increasing agent were added, and de-ionized water was added to adjust the viscosity at a temperature of about 25° C. of the composition to 35″ by Ford cup No. 4. A coating layer was formed through implementing the substantially same procedure described in Experiment 1.

Experiment 3

Into a paint composition including about 25% by weight of the resin composition prepared by Example 3, about 55% by weight of an aqueous pigment paste, about 2% by weight of an additional agent and about 0.5% by weight of an adhesiveness increasing agent were added, and de-ionized water was added to adjust the viscosity at a temperature of about 25° C. of the composition to 35″ by Ford cup No. 4. A coating layer was formed through implementing the substantially same procedure described in Experiment 1.

Experiment 4

Into a paint composition including about 25% by weight of the resin composition prepared by Comparative Example 1, about 55% by weight of an aqueous pigment paste, about 2% by weight of an additional agent and about 0.5% by weight of an adhesiveness increasing agent were added, and de-ionized water was added to adjust the viscosity at a temperature of about 25° C. of the composition to 35″ by Ford cup No. 4. A coating layer was formed through implementing the substantially same method described in Experiment 1.

For the coating layer formed according to the above-descried method, some properties were estimated. The properties of the coating layer were estimated by means of a common method of estimating the properties of the coating layer. That is, an orange peel or a gloss deterioration of the coating layer was observed with naked eyes to estimate the appearance of the coating layer. When no orange peel or gloss deterioration was observed, the coating layer was given to “excellent”, and when a great deal of orange peel was observed and the gloss cannot be distinguished, the coating layer was given to “bad”. Between the two levels, “good” and “common” are given according to the degree of the orange peel and the gloss deterioration.

Water-resistance was estimated after dipping a test sample into water at a temperature of about 50° C. for about ten days. An abnormal change of the coating layer was observed with naked eyes. When no change was observed after about 10 days, the coating layer was given to “excellent”, and when the surface portion of the coating layer became turbid as white or the gloss was deteriorated when comparing with the gloss of the original coating layer before the dipping, the coating layer was given to “bad”. Between the two levels, “good” and “common” were given according to the degree of the change of the coating layer.

The adhesiveness of the coating layer was estimated by separating the coating layer using a cellophane adhesive tape after forming 100 scales vertically and horizontally at intervals of 1 mm using a knife. When no separation was observed, the coating layer was given to “excellent”, and when even one piece was separated, the coating layer was given to “bad”. Between the two levels, “good” and “common” were given according to the degree of the separation.

The stability for storing the composition was estimated after standing the composition at a temperature of about 60° C. for about ten days. When no change was observed after standing the paint composition, the stability was given to “excellent”, and when the change of color and viscosity of the paint composition was severe and so the paint composition cannot be used, the stability was given to “bad”. Between the two levels, “good” and “common” were given according to the degree of the change of the color and viscosity of the composition.

Dispersing property of a pigment was estimated after stirring the paint composition and standing the same for about two days, according to the separating degree between the resin layer and pigment paste. When no separation was observed and the initial state of the composition was kept, the dispersing property was given to “excellent”, and when serious separation was observed and so the composition cannot be used, the dispersing property was given to “bad”. Between the two levels, “good” and “common” were given according to the degree of the separation between the resin layer and the pigment paste. The results are illustrated in Table 1.

TABLE 1

| | Experi- | Experi- | Experi- | Experi- |
|---|---|---|---|---|
| | ment 1 | ment 2 | ment 3 | ment 4 |
| Appearance | ⊚ | ⊚ | ⊚ | ◯ |
| Water-resistance | ⊚ | ⊚ | ◯ | ◯ |
| Adhesiveness | ⊚ | ⊚ | ⊚ | Δ |
| Storing stability | ◯ | ⊚ | ⊚ | Δ |
| Pigment | ⊚ | ⊚ | ⊚ | Δ |
| dispersing | | | | |

In Table 1,
⊚ represents excellent,
◯ represents good,
Δ reprsents common and
X represents bad.

As can be noted from Table 1, the coating layer including the water-borne resin composition for polyolefin and being formed by Experiments 1, 2 and 3 exhibits good appearance and good water-resistance when comparing with the coating layer formed by Experiment 4. In particular, physical properties including the adhesiveness, the storing stability and the pigment dispersing property were excellent for the paint composition and the coating layer of Experiments 1, 2 and 3.

Among the test results, the paint composition and the coating layer of Experiment 2 exhibit especially excellent storing stability and water-resistance. The water-borne resin composition prepared by Example 2 exhibits medium acid value.

As described above, the water-borne resin composition for polyolefin according to the present invention is prepared by means of a graft polymerization of propylene chloride resin with an acryl monomer resin including a monomer having a carboxyl functional group. The polymerization is implemented not by a simple blending at room temperature but by grafting at an elevated temperature using commercially available components. In addition, a small amount of the acryl monomer having the carboxyl functional group is used for the neutralization and dilution. Accordingly, the paint composition including the resin composition has good physical properties including adhesiveness, storing stability and dispersing property of pigments. In addition, the appearance and water-resistance of a coating layer formed by using the resin composition of the present invention are largely improved.

The water-borne resin composition can be advantageously applied to a substrate material requiring a high adhesiveness such as polyolefin-based substrate.

While the present invention is described in detail referring to the attached embodiments, various modifications, alternate constructions and equivalents may be employed without departing from the true spirit and scope of the present invention.

What is claimed is:

1. A water-borne resin composition for polyolefin obtained by graft polymerizing about 5 parts by weight to about 30 parts by weight of polypropylene chloride resin having a chlorine degree of about 10% by weight to about 40% by weight and about 70 parts by weight to about 95 parts by weight of an acryl monomer.

2. The water-borne resin composition for polyolefin of claim 1, wherein the composition has a hydroxide value of about 5 mg KOH/g to about 50 mg KOH/g, an acid value of about 6.5 mg KOH/g to about 60 mg KOH/g, and a number average molecular weight of about 60,000 to about 150,000.

3. The water-borne resin composition for polyolefin of claim 1, wherein the acryl monomer comprises an acryl monomer having a carboxyl functional group.

4. The water-borne resin composition for polyolefin of claim 3, wherein about 1% by weight to about 10% by weight of the acryl monomer having the carboxyl functional group is comprised based on an amount of the acryl monomer.

5. The water-borne resin composition for polyolefin of claim 3, wherein the acryl monomer having the carboxyl functional group comprises at least one selected from the group consisting of acrylic acid and methacrylic acid.

6. The water-borne resin composition for polyolefin of claim 1, wherein the acryl monomer comprises a non-functional acryl monomer comprising an aliphatic monomer and an alkyl-based monomer, and an acryl monomer having a hydroxyl functional group.

7. The water-borne resin composition for polyolefin of claim 6, wherein the resin composition comprises about 15% by weight to about 35% by weight of the aliphatic monomer, about 40% by weight to about 70% by weight of the alkyl-based monomer and about 5% by weight to about 15% by weight of the acryl monomer having the hydroxyl functional group based on an amount of the acryl monomer.

8. The water-borne resin composition for polyolefin of claim 6, wherein the aliphatic monomer comprises at least one selected from the group consisting of isobornyl acrylate, cyclohexyl acrylate, isobornyl methacrylate and cyclohexyl methacrylate,
the alkyl-based monomer comprises at least one selected from the group consisting of methyl acrylate, ethyl acrylate, n-butyl acrylate, methyl methacrylate, n-butyl methacrylate, isobutyl methacrylate and acrylonitrile, and
the acryl monomer having the hydroxyl functional group comprises at least one selected from the group consisting of 2-hydroxyethyl methacrylate, 2-hydroxyethyl acrylate, hydroxypropyl acrylate, hydroxypropyl methacrylate and hydroxybutyl acrylate.

9. The water-borne resin composition for polyolefin of claim 1, further comprising a cross-linking agent.

10. The water-borne resin composition for polyolefin of claim 9, wherein the cross-linking agent comprises at least one selected from the group consisting of an amino resin and a reactive urethane resin.

11. The water-borne resin composition for polyolefin of claim 1, wherein the initiator comprises benzoyl peroxide and an amount of the initiator is in a range of about 0.1 part by weight to about 5 parts by weight based on about 100 parts by weight of the acryl monomer.

12. A method of preparing a water-borne resin composition for polyolefin comprising:
preparing polypropylene chloride resin solution by mixing about 5 parts by weight to about 30 parts by weight of polypropylene chloride resin having a chlorine degree of about ten to about forty and about 5 parts by weight to about 30 parts by weight of a hydrophilic solvent;
preparing an acryl monomer solution by mixing about 70 parts by weight to about 95 parts by weight of an acryl monomer, a solvent and an initiator;
dropping the acryl monomer solution into the polypropylene resin solution at a temperature of about 80° C. to about 130° C.; and
neutralizing and diluting thus obtained product.

13. The method of claim 12, wherein the acryl monomer comprises an acryl monomer having a carboxyl functional group.

14. The method of claim 13, wherein about 1% by weight to about 10% by weight of the acryl monomer having the carboxyl functional group is included in the acryl monomer based on the amount of the acryl monomer.

15. The method of claim 13, wherein the acryl monomer having the carboxyl functional group comprises at least one selected from the group consisting of acrylic acid and methacrylic acid.

16. The method of claim 12, wherein the acryl monomer comprises a non-functional acryl monomer comprising an aliphatic monomer and an alkyl-based monomer, and an acryl monomer having a hydroxyl functional group.

17. The method of claim 16, wherein the resin composition comprises about 15% by weight to about 35% by weight of the aliphatic monomer, about 40% by weight to about 70% by weight of the alkyl-based monomer and about 5% by weight to about 15% by weight of the monomer having the hydroxyl functional group based on an amount of the acryl monomer.

18. The method of claim 16, wherein the aliphatic monomer comprises at least one selected from the group consisting of isobornyl acrylate, cyclohexyl acrylate, isobornyl methacrylate and cyclohexyl methacrylate,
the alkyl-based monomer comprises at least one selected from the group consisting of methyl acrylate, ethyl acrylate, n-butyl acrylate, methyl methacrylate, n-butyl methacrylate, isobutyl methacrylate and acrylonitrile, and
the acryl monomer having the hydroxyl functional group comprises at least one selected from the group consisting of 2-hydroxyethyl methacrylate, 2-hydroxyethyl acrylate, hydroxypropyl acrylate, hydroxypropyl methacrylate and hydroxybutyl acrylate.
